(19) United States
(12) Patent Application Publication
(10) Pub. No.: US 2008/0082870 A1
(43) Pub. Date: Apr. 3, 2008

(54) Parallel bit test device and method using error correcting code

(75) Inventor: Bok-gue Park, Hwaseong-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD

(21) Appl. No.: 11/902,261

(22) Filed: Sep. 20, 2007

(30) Foreign Application Priority Data
Sep. 29, 2006 (KR) 10-2006-0096136

(51) Int. Cl. G06F 11/00

(52) U.S. Cl. 714/704; 714/E11.001

(57) ABSTRACT

Example embodiments are directed to a parallel bit test device and method using error correcting code. The parallel bit test device may include an error detecting and correcting unit configured to count the number of fail bits in an m-bit data signal, for example, by comparing bits of the m-bit data signal with corresponding bits of expected data, where m is a positive integer, and to output correction signals. The error detecting and correcting unit may be further configured to perform at least one logic operation on a correction control signal and comparison signals. The correction control signal may be generated in response to a test mode register set (TMRS) signal set and input by a user such that the logic level of the correction control signal may vary according to the counted number of fail bits. Each comparison signal may include information about a fail bit and the address of the fail bit.

### PRIORITY STATEMENT

This application claims the benefit of Korean Patent Application No. 10-2006-0096136, filed on Sep. 29, 2006, in the Korean Intellectual Property Office, the entire contents of which are incorporated herein by reference.

### BACKGROUND

1. Field

Example embodiments are directed to a parallel bit test device, for example, a parallel bit test device using error correcting code (ECC).

2. Description of the Related Art

After manufacturing, the reliability and yield of semiconductor memory devices may deteriorate. Accordingly, an error recovery circuit may be used to detect, and possibly recover, defective memory cells.

The error recovery circuit may include redundancy circuits with redundancy cells, which may be used to replace defective cells. The error recovery circuit may also include an error correcting circuit to generate a parity bit from input data, correct an error, and/or output error-corrected data.

A semiconductor memory device having a redundancy circuit may disable a defective memory cell and enable a redundancy cell when a defect of the memory cell is detected. For example, the redundancy cell may read and write data in place of the defective memory cell. In a conventional redundancy circuit, a single redundancy cell may cover approximately sixteen memory cells disposed at intersections of approximately four wordlines and approximately four bit lines. Thus, the approximately sixteen memory cells may be replaced when a single defective memory cell is detected, for example, due to a small defect.

The error correcting circuit may correct an error generated when data bits are encoded, transmitted, decoded and/or outputted. The error correcting circuit may correct a fail bit of data and output the corrected data. The error correcting circuit may include an error detecting unit (for example, a parallel bit test device) to detect an error, and an output unit to correct the detected error and output error-corrected data. The error detecting unit may detect an error using ECC (error correcting code). ECC may be generated by calculating a parity bit from input data bits, and may be separately stored. The data bits and the parity bit may be encoded and written together, for example. The data bits and the parity bit may be checked when read. When an error is generated, the error may be detected and correction information output. The output unit of the error correcting circuit may correct data having the error using the correction information, and may output the error-corrected data as output data.

FIG. 1 is a block diagram of a conventional semiconductor memory device including a parallel bit test device using ECC. Referring to FIG. 1, the semiconductor memory device including the parallel bit test device may include a memory cell array 100, a parity generator 210, a parity memory cell array 220, an error detector 230, and/or an error corrector 240.

The memory cell array 100 may receive data bits Din, encode the received data bits, and store the encoded data bits. The parity generator 210 may receive the data bits Din and generate a parity bit Pi of the data bits Din. The parity bit Pi may be generated using a matrix formula, and may have various values according to parity bit generating methods. Parity bit generating methods are well known in the art, and a more detailed explanation thereof will be omitted here.

The parity memory cell array 220 may encode and store the parity bit Pi. The error detector 230 may detect whether an error is generated using the encoded data bits Di and the parity bit Pi, and may correct a bit having an error (fail bit) when the error is correctable. For example, if binary data bits 10011101 are input and transmitted as 10001101, the bit corresponding to 2⁴ may have an error. Thus, the error detector 230 may detect the fail bit 0, and the error corrector 240 may correct the fail bit 0 to 1.

The data bits Di and the parity bit Pi may be combined and encoded. The combined data Di+Pi may be referred to as Hamming code. Hamming code may be used to detect a fail bit and correct the fail bit in a parallel bit test device using ECC.

When an m-bit data signal is input having n data bits, and (m-n) parity bits are generated, the Hamming code (m, n) may have m bits. For example, commonly used Hamming codes may include (12, 8) and (15, 11). The number of parity bits Pi may depend on the number of data bits Di.

The number of parity bits Pi may be obtained according to the following formula: 2^{P}≧M+P+1. Here, M denotes the number of data bits Di and P represents the number of parity bits Pi. For example, when the Hamming code is 12-bits, the sum of data bits M and parity bits P is 12. Therefore, applying the above formula, M+P+1=12+1, which equals 13, and thus, in this example, P may be 4. The total number of bits of Hamming code may be 12, and thus M may be 12−4=8.

The parity bits may be separately stored and used when an error is detected or corrected. Accordingly, the parity memory cell array 220 may store the parity bits Pi. When the number of parity bits increases, the capacity of the parity memory cell array 220 may also be increased. Thus, the parity bits may be set to the smallest P that satisfies the above formula.

Conventional error correcting devices using Hamming code may detect one-bit errors of input data, however, when more than one fail bit is generated, the error correcting device may not be able to detect or correct the fail bits. Accordingly, because the probability of generating a given number of fail bits may scale with increases in the number of bits of input data, the probability of correcting an error may be reduced as the number of bits of input data increases.

FIG. 2 illustrates the flow of signals input/output to/from the parity generator 210 and the error detector 230 illustrated in FIG. 1. Referring to FIG. 2, a first parity generator 211 may receive 8-bit data Din0 through Din7, and may generate four parity bits P0, P1, P2 and P3 using the 8-bit data Din0 through Din7. Here, each Din may be designated by a number representing the position of bits of the input data. The parity bits P0, P1, P2 and P3 may be generated using a Hamming code system, for example. A second parity generator 212 may receive 8-bit data Din8 through Din15 and may generate four parity bits P4, P5, P6 and P7 using the 8-bit data Din8 through Din15.

The parity bits P0, P1, P2 and P3 generated by the first parity generator 211 may be stored in the parity memory cell array 220 illustrated in FIG. 1 and input to the error detector 230 illustrated in FIG. 1 when data is read. The error detector 230 may output data Ei used to detect a fail bit using data Di stored in the memory cell array 100 and the parity bits P0, P1, P2 and P3. One fail bit may be detected by the error detector 230. The data Ei may be data transferred and outputted, or data having address information of fail bits.

Accordingly, when more than two fail bits exist in the data Di input to a first error detector 231, the first error detector 231 may not detect the fail bits and may not generate the data Ei. For example, when data 00000000 is input and transmitted as 10000001 having fail bits D0 and D7 generated therein, the fail bits D0 and D7 may not be corrected and the data may not be transferred.

The conventional error correcting device illustrated in FIG. 1 may enable a data signal to be quickly compressed and tested, and may detect whether the compressed data signal has an error. For example, the conventional error correcting device may compress data loaded on four bit lines and transmit the compressed data as a single data signal Di. Accordingly, it may not be aware of the number of fail bits, and may detect only whether less than one bit error is generated.

FIG. 3A illustrates a conventional parallel bit test device 300 for detecting a fail bit. Referring to FIG. 3A, the conventional parallel bit test device 300 may use a fail bit counting method including a plurality of XOR gates 301, 302, 303 and 304 and an OR gate 311. The XOR gates 301, 302, 303 and 304 may respectively compare expected data bits ED0, ED1, ED2 and ED3 to transferred data bits CD0, CD1, CD2 and CD3 to detect a fail bit.

The conventional parallel bit test device 300 may compare transferred data CDi to expected data EDi to detect whether a fail bit is generated. For example, when the transferred data is 1101 and the original data before transfer is 1100, CDi may be 1101 and EDi may be 1100. Each XOR gate may output 0 when the received two signals are the same as each other and output 1 when the received two signals are different from each other. Thus, XOR gate 301 receiving CD0 and ED0 (1 and 0, respectively, in this example) may output 1. XOR gates 302, 303 and 304 may each output 0 because their input data bits are identical, in this example. The OR gate 311 may receive 1, 0, 0 and 0, perform an OR operation on the received data bits, and output 1. Therefore, the conventional parallel bit test device 300 may determine that a fail bit may be generated when the output DQ0 of the OR gate 311 is 1, and that a fail bit may not be generated when the output DQ0 of the OR gate 311 is 0.

The output DQ0 of the OR gate 311 may be transmitted to a data output unit DQ. For example, a logic high signal “1” representing that a fail bit is generated may be transmitted to the data output unit DQ and the result of the test may be confirmed. However, the conventional parallel bit test device 300 may not be able to count the number of fail bits and detect the position of a fail bit.

FIG. 3B is a timing diagram of signals input/output to/from the parallel bit test device illustrated in FIG. 3A. Referring to FIG. 3B, an activation signal ACT 351 for activating bit lines may be input at a rising edge of a clock signal CLK, for example, to read the data CDi transferred and stored. A read signal READ may be input at the next rising edge of the clock signal CLK, for example, as well as the expected data signal EDi.

### SUMMARY

A parallel bit test device according to example embodiments may include an error detecting and correcting unit configured to count a number of fail bits in an m-bit data signal, where m is a positive integer, and to output correction signals. The error detecting and correcting unit may be configured to count the number of fail bits in the m-bit data by comparing the bits of the m-bit data signal with corresponding bits of expected data to determine whether the bits of the m-bit data signal are the same as the bits of the expected data. The m-bit data signal may include n data bits and (m-n) parity bits, where n is a positive integer not greater than m.

The error detecting and correcting unit may be further configured to perform at least one logic operation on a correction control signal and comparison signals. The correction control signal may be generated in response to a test mode register set (TMRS) signal set and input by a user such that the logic level of the correction control signal may vary according to the counted number of fail bits. Each comparison signal may include information about a fail bit and the address of the fail bit.

The error detecting and correcting unit may include a fail bit controller. The fail bit controller may include an adder and/or a fail estimator. The adder may be configured to add up the number of fail bits using error comparison signals including information about whether the bits of the m-bit data signals are the same as the corresponding bits of the expected data. The fail estimator may be configured to output the correction control signal at a logic level which may vary according to the number of fail bits, in response to the test MRS signal.

The parallel bit test may also include a data input unit configured to receive and output the m-bit data signal. The data input unit may be configured to output m/k compressed data signals to the error detecting and correcting unit, where k is a positive integer not greater than m. The m/k compressed data signals may be obtained by grouping the m-bit data signal into groups each having k bits.

The error detecting and correcting unit may also include a transfer data comparator, a comparison signal generator and/or a fail bit detecting and correcting unit. The transfer data comparator may be configured to compare the bits of the m-bit data signal to the corresponding bits of the expected data and to output the error comparison signals. The comparison signal generator may be configured to determine whether any of k error comparison signals have the same value and to output the comparison signals. The comparison signals may include information about whether any of the k error comparison signals have the same value. The fail bit detecting and correcting unit may be configured to generate the correction signals by performing the at least one logic operation on the correction control signal and the comparison signals.

The test MRS signal may be set and input by a user, for example, such that the correction control signal is outputted when the counted number of fail bits is 1 or less.

The transfer data comparator may include m XOR gates each respectively receiving a bit of the m-bit data signal and the corresponding bit of the expected data, and performing exclusive OR operations on the bits of the m-bit data and the corresponding bits of the expected data to output the error comparison signals. The comparison signal generator may include m/k XNOR gates receiving and performing XNOR operations on the error comparison signals to output the m/k comparison signals. The fail bit detecting and correcting unit may include m/k OR gates respectively receiving and performing OR operations on the correction control signal and a comparison signal to generate the correction signals.

The correction control signal may have a logic high level when the number of fail bits is 1 or less, and may have a logic low level when the number of fail bits is 2 or greater, for example.

The parallel bit test device may also include an output unit configured to select and output the original data signal or a corrected data signal according to the correction signals. The output unit may be configured to output error-corrected compressed data or the original compressed data when the correction signals have a logic high level, and to not output compressed data when the correction signals have a logic low level. For example, the output unit may be configured to output the original compressed data when the correction signals have a logic high level and the number of fail bits is 0, and to correct the fail bit and output the corrected compressed data when the correction signals have a logic high level and the number of fail bits is 1. The output unit may be configured to correct the fail bit by replacing bit lines corresponding to the compressed data having the fail bit with redundancy bit lines.

According to an example embodiment, m may be 12, n may be 4, and/or k may be 4. The parallel bit test device may include L data input units, L error detecting and correcting units and L output units when L m-bit data signals are input to the parallel bit test device, where L is a positive integer.

A method of error detecting and correcting in a parallel bit test device according to an example embodiment may include comparing bits of an m-bit data signal with corresponding bits of expected data. The number of fail bits may be counted based on whether the bits of the m-bit data signal are the same as the corresponding bits of expected data. A correction control signal may be generated based on the counted number of fail bits and a user input test mode register set (TMRS) signal. Comparison signals may be generated based on the number of fail bits and the address of each fail bit. Correction signals may be generated and output by performing at least one logic operation on the correction control signal and the comparison signals.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a conventional parallel bit test device using an Error Correcting Code (ECC).

FIG. 2 illustrates flows of signals input/output to/from the parity generator and error detector of FIG. 1.

FIG. 3A is a circuit diagram of a conventional parallel bit test device for detecting the generation of a fail bit.

FIG. 3B is a timing diagram of signals used to drive the conventional parallel bit test device of FIG. 3A.

FIG. 4 illustrates example bit lines used in a parallel bit test device according to an example embodiment.

FIG. 5 is a block diagram of a parallel bit test device according to an example embodiment.

FIG. 6 is a block diagram of the example fail bit controller of FIG. 5.

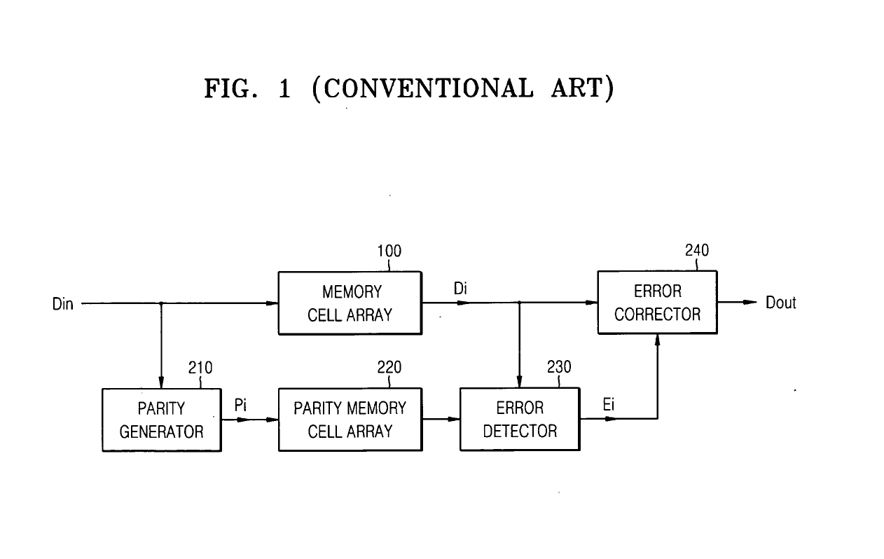

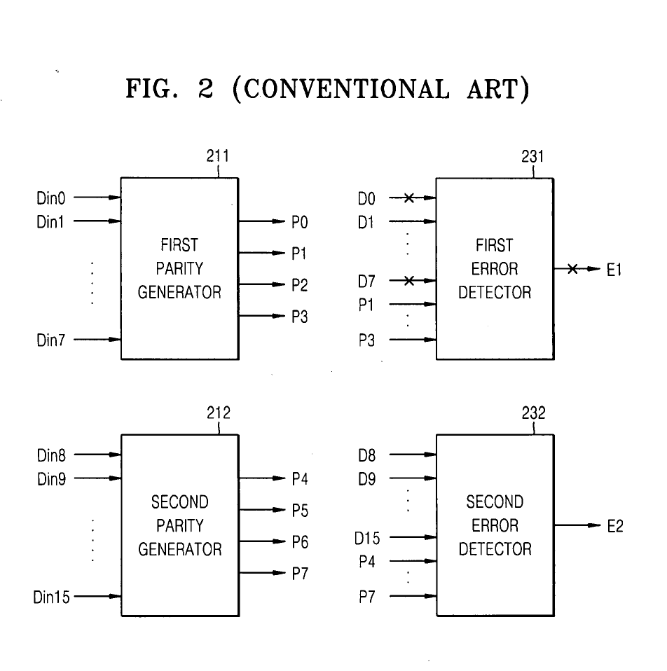

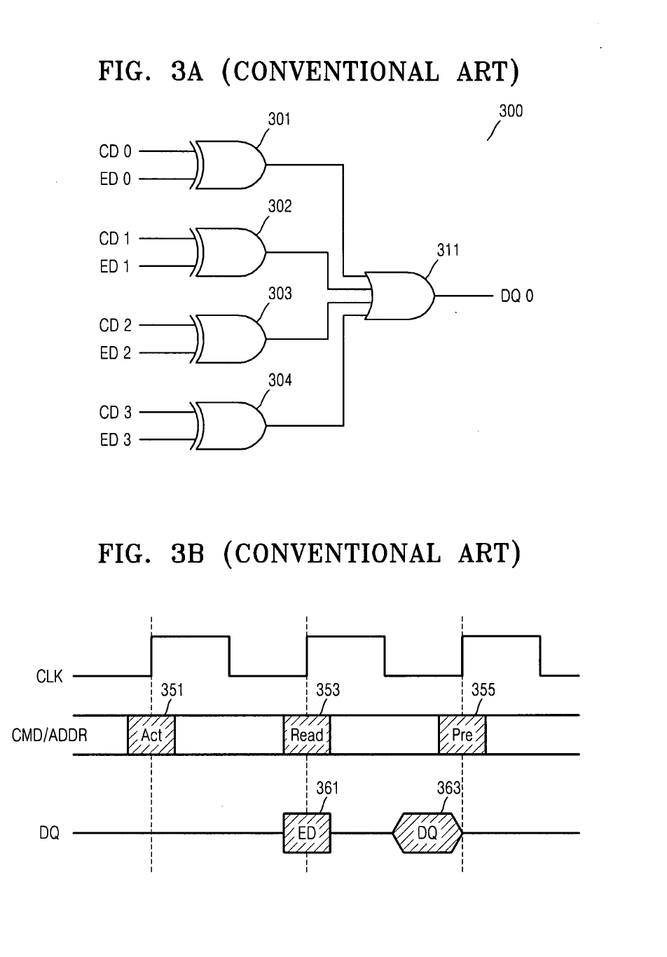

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives failing within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

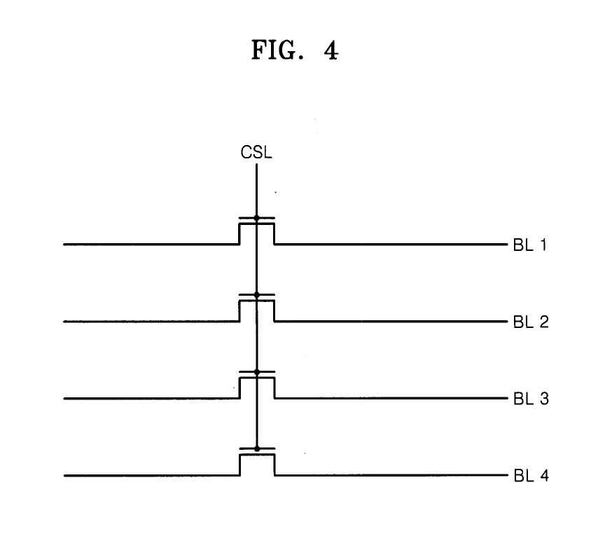

FIG. 4 illustrates bit lines BL1, BL2, BL3 and BL4 used in a parallel bit test device according to an example embodiment. Referring to FIG. 4, the parallel bit test device may compress data loaded on four bit lines BL1, BL2, BL3 and BL4 into a single transfer data signal DQi. In a semiconductor memory device including the parallel bit test device according to an example embodiment, a single column select signal CSL may be used to input the four bit lines BL1, BL2, BL3 and BL4. For example, when the column select signal CSL is at a logic high level, the four bit lines BL1, BL2, BL3 and BL4 may be simultaneously activated.

While the data of the four bit lines may be illustrated as included in a single transfer data signal in FIG. 4, it will be understood by those of ordinary skill in the art that the number of bit lines is not limited to four.

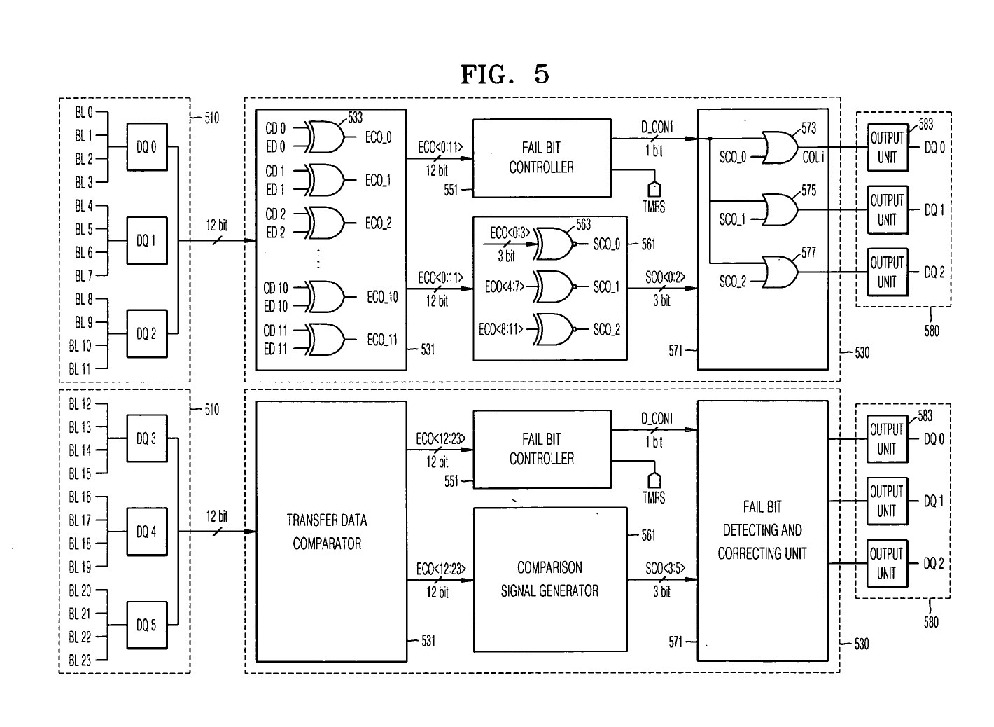

FIG. 5 is a block diagram of a parallel bit test device according to an example embodiment. Referring to FIG. 5, the parallel bit test device may include a plurality of data input units 510, a plurality of error detecting and correcting units 530, and/or a plurality of output units 580.

Each data input unit 510 may receive an m-bit data signal including n data bits and (m-n) parity bits, where m and n are positive integers, and n is not greater than m. The m-bit data signal may be compressed by k bits to form m/k compressed data signals DQ, where k is a positive integer not greater than m. For example, as shown in FIG. 5, n may be 8, m may be 12 and k may be 4. Following this example, Hamming code (12, 8) may be input to the data input unit 510 and compressed into a single data signal DQ including four bits (k=4). Accordingly, as shown, a first Hamming code (data received through bit lines BL0 through BL11) may be input and compressed into data signals DQ0, DQ1 and DQ2, and a second Hamming code (data received through bit lines BL12 through BL23) may be input and compressed into data signals DQ3, DQ4 and DQ5.

Each data input unit 510 may compress 12-bit data (a single Hamming code) into three compressed data signals DQ, and output the three compressed data signals DQ to a corresponding error detecting and correcting unit 530.

Each error detecting and correcting unit 530 may include a transfer data comparator 531, a fail bit controller 551, a comparison signal generator 561, and/or a fail bit detecting and correcting unit 571. The error detecting and correcting unit 530 may count the number of fail bits using ECC and detect the addresses of fail bits. An error correcting range may be controlled by a user by setting a test mode register set (test MRS or TMRS) signal and inputting the test MRS signal to the parallel bit test device. To correct, for example, 1-bit error for a data signal input as a 12-bit Hamming code, the test MRS signal may be set such that a correction control signal D_CON may be output to the parallel bit test device when one fail bit or less is generated. The activation level of the correction control signal D_CON may be set to logic high or logic low. For example, in the example embodiment illustrated in FIG. 5, the activation level of the correction control signal D_CON may be a logic high level.

Each transfer data comparator 531 may respectively compare input data bits CD0 through CD11 to expected data bits ED0 through ED11, and output error comparison signals ECO_i having information indicating whether the input data bits CD0 through CD11 are the same as the expected data bits ED0 through ED11. The data bits CDi may correspond to a signal loaded and transferred on bit lines BLi, and the expected data bits EDi may correspond to the initially input data bits (the data bits prior to being transferred through bit lines). For example, if data 1101 is input to a Memory Chip and is read as 1100 at a receiving side of PBT device (Parallel Bit Test device), 1100 may correspond to the data bits CDi and 1101 may correspond to the expected data bits EDi.

The data bits CDi may be checked against the expected data bits EDi using XOR gates. For example, the transfer data comparator 531 may include m XOR gates when an m-bit data signal is input. An XOR gate may output 0 when signals input thereto are the same as each other and output 1 when the input signals are different from each other. Thus, it may be determined whether the data bits CDi are the same as the expected data bits EDi using XOR gates.

It may be determined that the data bits CDi are the same as the expected data bits EDi when all the error comparison signals ECOi have a value 0, or that the data bits CDi do not correspond to the expected data bits EDi when any of the error comparison signals ECOi has a value 1. If the data bits CDi do not have any fail bits, the data bits CDi may match the expected data bits EDi.

The fail bit controller 551 may count the number of error comparison signals ECOi having a value 1 and determine whether the correction control signal D_CON may be output at a logic high level in response to the test MRS signal applied thereto.

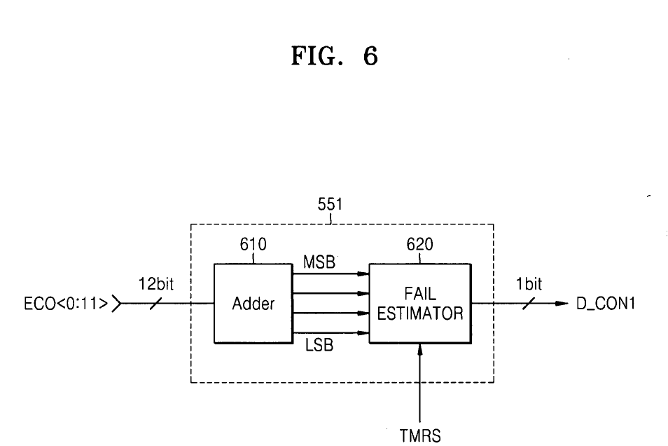

FIG. 6 is a block diagram of the fail bit controller illustrated in FIG. 5. Referring to FIG. 6, the fail bit controller 551 may include an adder 610 and/or a fail estimator 620. The adder 610 may receive, for example, twelve error comparison signals ECOi, count the number of error comparison signals ECOi having a value 1, and output a 4-bit data signal. When each of the twelve error comparison signals ECOi has a value 1, the adder 610 may output 1100, for example. The error comparison signals ECOi may be output as 1 when data bits corresponding thereto are fail bits. Accordingly, when the number of error comparison signals ECOi is counted, the number of fail bits may be known.

The fail estimator 620 may receive the 4-bit data signal output from the adder 610 and output the correction control signal D_CON in response to the test MRS signal TMRS. As described above, the test MRS signal TMRS may be set and input by a user such that the correction control signal D_CON is output when the counted number of fail bits is less than a given number. For example, the test MRS signal TMRS may be used to set a threshold of the counted number of fail bits needed to output the correction control signal D_CON.

For example, if the user wants to correct fail bits when the number of fail bits is 2 or less, the test MRS signal TMRS may be set such that the correction control signal D_CON at a logic high level is output when the counted value is 2 or less (for example, when the counted number is 0010, 0001 or 0000).

The fail bit detecting and correcting unit 571, which will be described later, may include OR gates such that fail bits may be corrected when the correction control signal D_CON at a logic high level is applied thereto.

The case where the test MRS signal TMSR is set such that fail bit correction is carried out when the number of fail bits is 1 or less will be explained below.

Referring back to FIG. 5, the comparison signal generator 561 may determine whether a given number of error comparison signals ECOi have the same value, and output comparison signals SCOi having information representing whether the error comparison signals have the same value. For example, as shown in FIG. 5, the comparison signals SCOi may contain information representing whether four error comparison signals ECOi have the same value. When the error comparison signals ECOi are represented as X and the comparison signals SCOi are represented as Y, a matrix [A] satisfying the relationship of [A][X]=[Y] may be used. The matrix [A] may be set by a user through various methods. The address of a fail bit CDi may be detected by analyzing [Y]. There are various methods of analyzing the address and these methods are well known in the art.

The comparison signal generator 561 may include m/k XNOR gates. For example, because m=12 and k=4 in the example embodiment of FIG. 5, as described above, the comparison signal generator 561 may include three XNOR gates 563. When the error comparison signals ECO_0, ECO_1, ECO_2 and ECO_3 are respectively 0, 0, 1 and 0, for example, an XNOR gate 563 receiving the error comparison signals ECO_0, ECO_1, ECO_2 and ECO_3 may output 0.

Each fail bit detecting and correcting unit 571 may include m/k OR gates 573, 575 and 577 and perform OR operations on the error correction signal D_CON and the comparison signals SCO_i to generate correction signals COLi. For example, when the data bit CD5 transferred through the bit line BL5 is a fail bit and the other data bits CD0 through CD4 and CD6 through CD11 do not have errors, D_CON1 may be 1, SCO_0 may be 1, SCO_1 may be 0 and SCO_2 may be 1. When the test MRS signal TMRS is set such that fail bit correction may be carried out when the number of fail bits is one or less, each of the three OR gates 573, 575 and 577 may output 1.

Each output unit 580 may correct a fail bit and output the corrected bit when the correction signals COLi at a logic high level are input thereto. Each output unit 580 may output the compressed data DQi when the correction signals COLi at a logic high level are input thereto and the output value of the adder 610 is 0.

Because the parallel bit test device may detect a fail bit but may not correct the fail bit, the output unit 580 may be located outside the parallel bit test device. However, the output unit 580 may be included in the parallel bit test device together with the error detecting and correcting unit 530.

A fail bit may be corrected such that the address of the fail bit is detected using the comparison signals SCO_i and the error comparison signals ECO_i, and the fail bit may be inverted (for example, because when the fail bit is 0 the original data bit may be 1 in the binary system). For example, the compressed data DQi having a fail bit may be detected using the comparison signals SCO_i and replaced with corrected compressed data.

The logic levels of the correction signals COLi may vary according to the logic devices included in the fail bit detecting and correcting unit 571. For example, if the fail bit detecting and correcting unit 571 uses NOR gates, instead of OR gates 573, the correction signals COLi may have a logic low level.

When the correction signals COLi are applied at a logic level that does not activate correction, the compressed data DQi may not be outputted. For example, data may not be transmitted because a fail bit generated in the data may not be corrected. The parallel bit test device according to an example embodiment may not correct a fail bit and may not output the compressed data DQi when the correction signals COLi at a logic low level are applied thereto.

As described above, a parallel bit test device according to example embodiments may include an adder and may set a test MRS signal according to a fail condition set by a user to detect a number of fail bits. Furthermore, the parallel bit test device may detect the position of a fail bit.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A parallel bit test device, comprising:
an error detecting and correcting unit configured to count a number of fail bits in an m-bit data signal, where m is a positive integer, and to output correction signals.

2. The parallel bit test device of claim 1, wherein the error detecting and correcting unit is configured to count the number of fail bits in the m-bit data signal by comparing the bits of the m-bit data signal with corresponding bits of expected data to determine whether the bits of the m-bit data signal are the same as the bits of the expected data, the m-bit data signal including n data bits and (m-n) parity bits, where n is a positive integer less not greater than m.

3. The parallel bit test device of claim 2, wherein the error detecting and correcting unit is further configured to perform at least one logic operation on a correction control signal and comparison signals, the correction control signal being generated in response to a test mode register set (TMRS) signal set and input by a user such that the logic level of the correction control signal varies according to the counted number of fail bits, and each comparison signal including information about a fail bit and the address of the fail bit.

4. The parallel bit test device of claim 3, further comprising:
a data input unit configured to receive and output the m-bit data signal.

5. The parallel bit test device of claim 4, wherein the error detecting and correcting unit includes a fail bit controller, the fail bit controller comprising:
an adder configured to add up the number of fail bits using error comparison signals including information about whether the bits of the m-bit data signals are the same as the corresponding bits of the expected data; and
a fail estimator configured to output the correction control signal at a logic level which varies according to the number of fail bits, in response to the test MRS signal.

6. The parallel bit test device of claim 5, wherein the data input unit is configured to output m/k compressed data signals, where k is a positive integer not greater than m, obtained by grouping the m-bit data signal into groups each having k bits to the error detecting and correcting unit.

7. The parallel bit test device of claim 6, wherein the error detecting and correcting unit further comprises:
a transfer data comparator configured to compare the bits of the m-bit data signal to the corresponding bits of the expected data and to output the error comparison signals;
comparison signal generator configured to determine whether any of k error comparison signals have the same value and to output the comparison signals, the comparison signals including information about whether any of the k error comparison signals have the same value; and
a fail bit detecting and correcting unit configured to generate the correction signals by performing the at least one logic operation on the correction control signal and the comparison signals.

8. The parallel bit test device of claim 7, wherein the test MRS signal is set and input by a user such that the correction control signal is outputted only when the counted number of fail bits is 1 or less.

9. The parallel bit test device of claim 7, wherein the transfer data comparator includes m XOR gates each respectively receiving a bit of the m-bit data signal and the corresponding bit of the expected data, and performing exclusive OR operations on the bits of the m-bit data and the corresponding bits of the expected data to output the error comparison signals.

10. The parallel bit test device of claim 9, wherein the comparison signal generator includes m/k XNOR gates receiving and performing XNOR operations on the error comparison signals to output the m/k comparison signals.

11. The parallel bit test device of claim 10, wherein the fail bit detecting and correcting unit includes m/k OR gates respectively receiving and performing OR operations on the correction control signal and a comparison signal to generate the correction signals.

12. The parallel bit test device of claim 11, wherein the correction control signal has a logic high level when the number of fail bits is 1 or less, and has a logic low level when the number of fail bits is 2 or greater.

13. The parallel bit test device of claim 7, further comprising:
an output unit configured to select and output the original data signal or a corrected data signal according to the correction signals.

14. The parallel bit test device of claim 13, wherein the output unit is configured to output error-corrected compressed data or the original compressed data when the correction signals have a logic high level, and to not output compressed data when the correction signals have a logic low level.

15. The parallel bit test device of claim 14, wherein the output unit is configured to output the original compressed data when the correction signals have a logic high level and the number of fail bits is 0, and to correct the fail bit and output the corrected compressed data when the correction signals have a logic high level and the number of fail bits is 1.

16. The parallel bit test device of claim 15, wherein the output unit is configured to correct the fail bit by replacing bit lines corresponding to the compressed data having the fail bit with redundancy bit lines.

17. The parallel bit test device of claim 6, wherein m is 12 and n is 4.

18. The parallel bit test device of claim 17, wherein k is 4.

19. The parallel bit test device of claim 6, wherein the parallel bit test device includes L data input units, L error detecting and correcting units and L output units when L m-bit data signals are input to the parallel bit test device, where L is a positive integer.

20. A method of error detecting and correcting in a parallel bit test device, comprising:
comparing bits of an m-bit data signal with corresponding bits of expected data, where m is a positive integer;
counting a number of fail bits based on whether the bits of the m-bit data signal are the same as the corresponding bits of expected data;
generating a correction control signal based on the counted number of fail bits and a user input test mode register set (TMRS) signal;
generating comparison signals based on the number of fail bits and the address of each fail bit; and
generating and outputting correction signals by performing at least one logic operation on the correction control signal and the comparison signals.
